(19) United States
(12) Patent Application Publication
(10) Pub. No.: US 2003/0016300 A1
(43) Pub. Date: Jan. 23, 2003

(54) Structure of a chip package

(76) Inventor: Chih-Yu Ting, Taipei City (TW)

Correspondence Address: Chih-Yu Ting, P.O. Box 82-144, Taipei, TW

(21) Appl. No.: 09/910,053

(22) Filed: Jul. 23, 2001

(51) Int. Cl. H04N 5/225; G02B 13/16

(52) U.S. Cl. 348/335; 348/340

(57) ABSTRACT

An improved structure of a chip package is disclosed. The improved structure of a chip package for used in the package structure of a digital photographic lens device with hidden chip connected with transmission lines, characterized in that the improved structure comprises a sectional of flexible circuit board and a hard thin board and the mounting legs of the photographic lens device assembly are mounted onto the flexible photographic lens device assembly having corresponding electrically connection points, and the flexible circuit board is connected to the back panel of the digital photographic lens device and is mounted with the hard thin plate.

### BACKGROUND OF THE INVENTION

(a) Field of the Invention

The present invention relates to an improved structure of a chip package, and in particular, a package structure with chip used in digital photographic lens device connected with a plurality of transmission lines. Flexible circuit board is employed directly as transmission lines for the photographic lens device.

(b) Description of the Prior Art

FIG. 1 is a conventional package structure with chips for a digital photographic lens device connected with transmission lines. As shown in FIG. 1, the connection legs at the base housing 10 of a photographic lens device 1 are first mounted onto a hard base seat 20 (being fabricated from a ceramic or PC board material). The surrounding of the base seat 20 is provided with a plurality of lines 21 connected to the connection legs of the chip 11. The hard base seat 20 is soldered to other layout transmission lines or other hard circuit board with electronic components of related functions. After that, chips 11 which convert images into digital signals, a lens 12, and a top housing 13 are stacked and packaged, forming into the digital photographic lens assembly 1, as shown in FIG. 2. When other hard circuit boards are connected with the lens assembly, the body, after packaging, is extended but the components cannot be bent or minimized in volume. The digital photographic lens assembly 1 can be made into a small size. However, after the assembly 1 is externally mounted with other PCB, the body of the lens assembly 1 becomes rather huge. To the manufacturers, if the components can be folded and can be located within a similar space the number of components therein can be increased, and consequently, the space for storage and shipping can be reduced. Therefore, the drawback of this conventional structure has to be overcome by improving the size of the package so that it can be folded to minimize the shape thereof.

Further, the conventional package structure includes materials, which are not flexible, and therefore, after the package structure is fitted within a housing the position is fixed and cannot be moved. As a result, minor adjustment or adjustment to a different angle cannot be obtained. Therefore, adjustment of object angle and distance (for example, with telescopic lens) cannot be obtained.

Accordingly, it is an object to provide an improved structure of a chip package, which mitigates the drawbacks found in production, such as a waste of space, the mounting position being fixed, multiple components could not be mounted, etc.

### SUMMARY OF THE INVENTION

Accordingly, it is an object of the present invention to provide an improved structure of a chip package, wherein a flexible circuit board is folded or bent to minimize the volume of the entire structure such that more components can be mounted with a similar space and the space is used to the greatest extent.

Yet another object of the present invention to provide an improved structure of a chip package, wherein minor adjustment of the digital photographic lens device can be obtained, allowing slight adjustment of the shooting angle and distance of the object.

An aspect of the present invention is to provide an improved structure of a chip package for used in the package structure of a digital photographic lens device with hidden chip connected with transmission lines, characterized in that the improved structure comprises a section of flexible circuit board and a hard thin board and the mounting legs of the photographic lens assembly are mounted onto the flexible circuit board having corresponding electrically connection points, and the flexible circuit board is connected to the back panel of the digital photographic lens device and is mounted with the hard thin plate.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional package structure of chips

FIG. 2 is a lateral view of the conventional package structure of chips.

FIG. 3 is a perspective exploded view of the chip package structure of the preferred embodiment in accordance with the present invention.

FIG. 4 is a perspective exploded view of the chip package structure of another preferred embodiment in accordance with the present invention.

FIG. 5 is a perspective view showing the folding of the chip package shown in FIG. 4 in accordance with the present invention.

FIG. 6 is a schematic view showing the chip package of the present invention being employed in a digital photographic lens device.

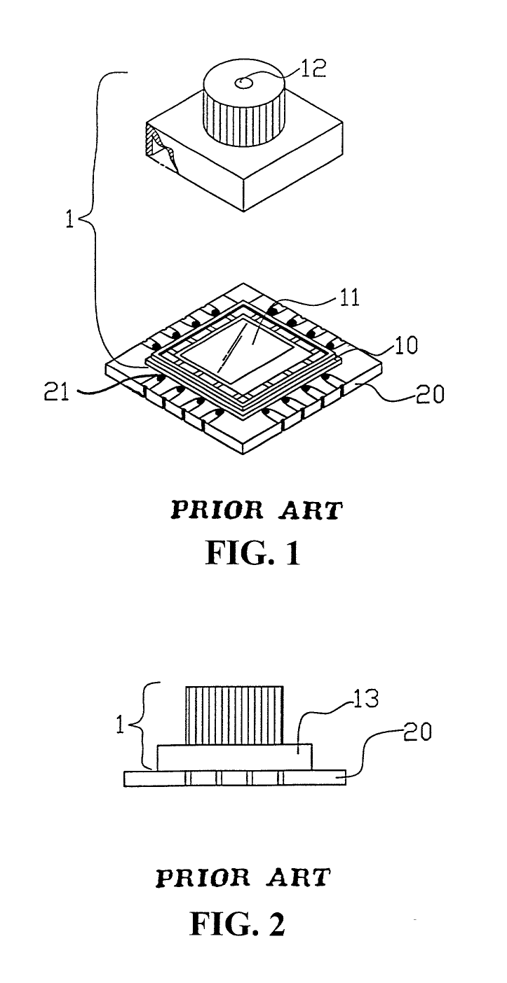

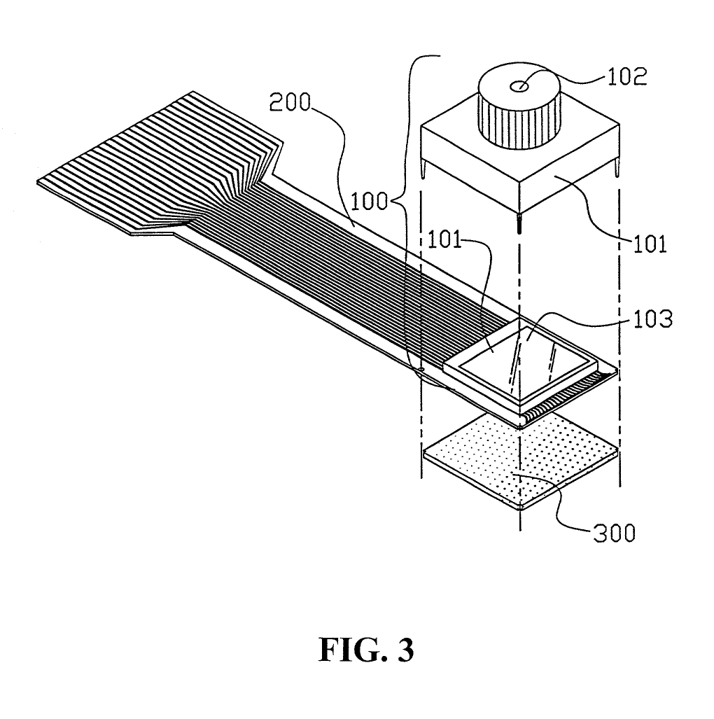

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

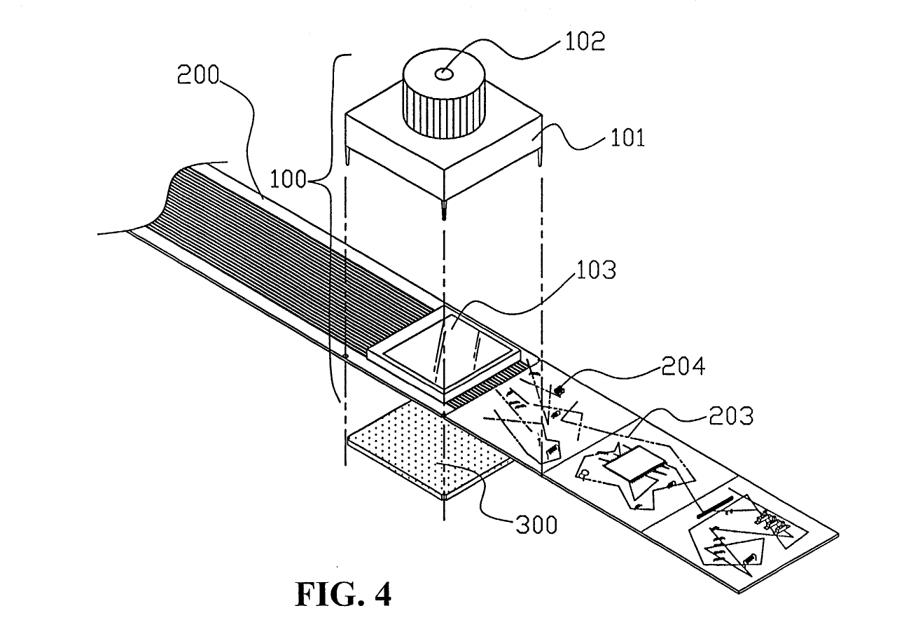

FIG. 2 is a perspective view showing an improved structure of the chip package implemented on a digital photographic lens device. As shown in the figure, the present improved structure of the chip package can be used in digital photographic lens device with hidden chip connected to transmission lines. The digital photographic lens device has a lens device assembly 100, a flexible circuit board 200 and a hard thin plate 300. The digital photographic lens assembly 100 does not has a base housing 10, and a hard base seat 20 as that of a conventional photographic assembly. The digital photographic assembly 100 includes a top housing 101, a lens 102 and chip 103. On the package structure, the digital photographic lens assembly 100 is mounted onto the flexible circuit board 200 having corresponding electrical connection points. The flexible circuit board 200 is connected to the back panel of the digital photographic lens device, and is mounted with the hard thin plate 300 to provide supporting strength and insulation at the connection thereof. Thus, the chip 103 can be mounted at a corresponding position on the flexible circuit board 200 by surface mounting technology. After that, on the bottom of the board 200 the hard thin plate 300 is then mounted. After that a top housing 101 is mounted onto the hard thinplate 300 and is formed into a solid structure. In implementation, as shown In FIG. 4, the flexible circuit board 200 can be an electrically conductive connection points printed onto a continuation strap body so that the flexible circuit board 200 is pre-fabricated and packed into a reel, facilitating production process. The reel is continuously packed and subsequently cut into sections. The flexible circuit board 200 is extended out at one end of the digital photographic assembly 100 and a folded length is reserved. The surface of the flexible circuit board 200 is layout with flexible electrically connection circuit of related circuit 203. On the circuit 203, related electronic components 204 are soldered. Thus, the related electronic components 204 on the hard circuit board is not needed to proceed with the soldering of the electronic components 204.

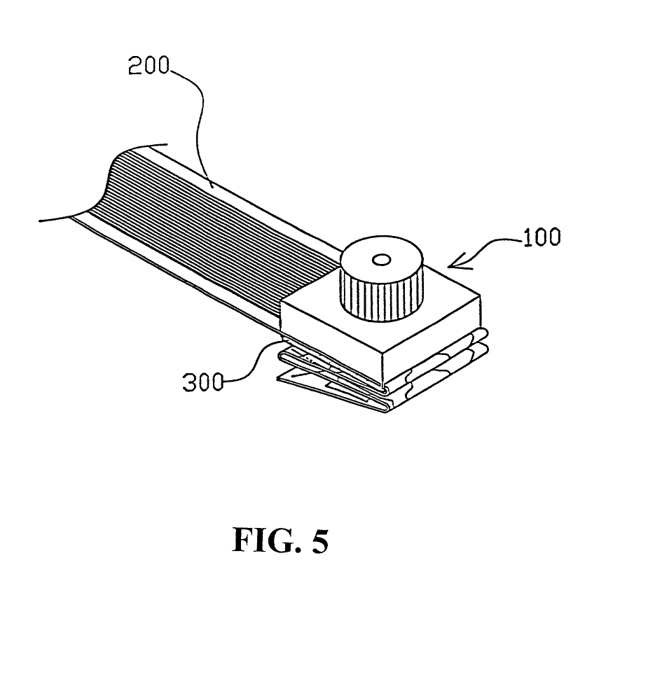

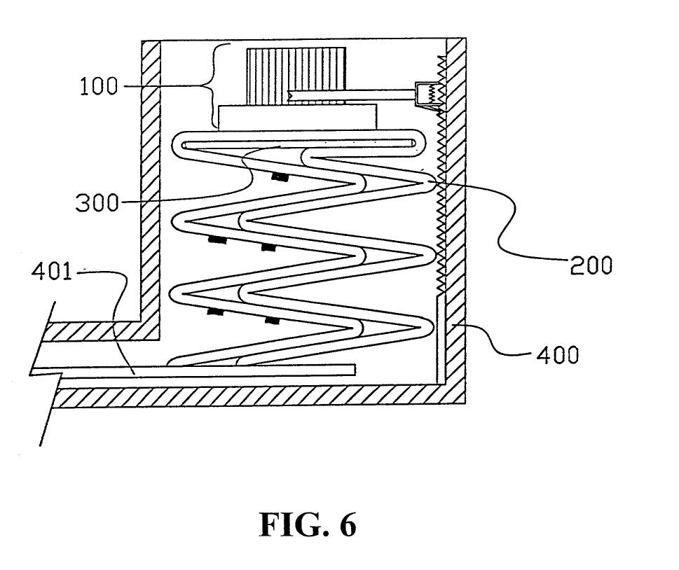

After the entire structure is packed, i.e., as shown in FIG. 5, the bottom of the lens assembly 100 is provided with a folded flexible circuit board 200 to increase the volume of directional extension. The flexible circuit board 200 is flexural and therefore, the lens assembly 100 can be bent to various position, or as shown in the figure, the circuit board 200 which is extended out of the photographic lens assembly 100, includes the electronic components 204 on the board 200, is bent to the bottom of the hard thin board 300 to form a plurality of folds. By means of the folding of the flexible circuit board 200, the height of the position of the mounting can be changed, or allows angle of photography or and the distance of the object. As shown in FIG. 6, there is shown another preferred embodiment of the present invention, prior to the soldering of electronic components 204, the flexible circuit board 200 surrounds the entire lens assembly 100 so as to minimize the volume, facilitating shipment or storage.

In view of the above, the present improved structure of a chip package facilitates the mounting position and minimizes the volume, facilitating shipping or storage space, and employs a minimum space to accommodate a maximum of parts.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a chip package for used in the package structure of a digital photographic lens device with hidden chip connected with transmission lines, characterized in that the improved structure comprises a sectional of flexible circuit board and a hard thin board and the mounting legs of the photographic lens device assembly are mounted onto the flexible photographic lens device assembly having corresponding electrically connection points, and the flexible circuit board is connected to the back panel of the digital photographic lens device and is mounted with the hard thin plate.

2. The improved structure of a chip package as set forth in claim 1, wherein the flexible circuit board is an electrically conductive connection points being printed on one section of the continuation strap body.

3. The improved structure of a chip package as set forth in claim 1 or 2, wherein the section of the flexible circuit board, extended out from one end of the digital photographic lens device assembly is formed with a reserved folded length and the surface of the plate is provided with flexible conductive connection circuit of related circuit.
